(19) United States
(12) Patent Application Publication
(10) Pub. No.: US 2026/0028114 A1
(43) Pub. Date: Jan. 29, 2026

(54) AIRCRAFT PORTION COMPRISING A CABIN TRIM PANEL

(71) Applicant: DASSAULT AVIATION, Paris (FR)

(72) Inventors: Olivier CAPISTRAN, Little Rock, AR (US); Benjamin Bush, Little Rock, AR (US); Quentin Foos, Saint-Cloud Cedex (FR); Matthieu Hautem, Saint-Cloud Cedex (FR)

(21) Appl. No.: 18/784,833

(22) Filed: Jul. 25, 2024

(51) Int. Cl. B64C 1/14

(52) U.S. Cl. CPC B64C 1/14

(57) ABSTRACT

A portion of an aircraft includes a fuselage. The fuselage includes a ceiling and a lateral portion of fuselage delimiting a cabin. The cabin trim panel also includes at least one technical equipment item mounted on the lateral portion of fuselage and at least one trim panel intended for at least partially concealing from the cabin, the at least one technical equipment item. The at least one trim panel is mounted rotatable about a horizontal axis of rotation on the ceiling between a trimming position so the trim panel at least partially conceals the at least one technical equipment item from the cabin by being held on the lateral portion of fuselage and a maintenance position so the trim panel is arranged at a distance from the lateral portion of fuselage in a substantially vertical plane to free access to the at least one technical equipment item.

The present disclosure relates to a portion of aircraft comprising a fuselage, at least one technical equipment item and at least one trim panel intended to at least partially conceal from the cabin the at least one technical equipment item.

For example, in a known portion of aircraft, the technical equipment item is mounted on an inner surface of the trim panel, the trim panel being mounted rotatably about a horizontal axis of rotation on a lateral portion of the fuselage.

### BACKGROUND

In such a portion of aircraft, excluding maintenance, the trim panel at least partially hides the technical equipment item from the cabin by being retained on a ceiling of the fuselage. When maintenance is required, the trim panel is rotated about the horizontal axis of rotation to a maintenance position wherein the trim panel is arranged away from the ceiling, such that the inner surface of the trim panel on which the technical equipment item is mounted is oriented substantially towards the inside of the cabin. Thereby, an operator can have access to the technical equipment, to carry out the maintenance operation.

However, in such a portion of an aircraft, the fact that the equipment item is mounted on the trim panel requires long lengths of electrical cables, pipes and/or mechanical elements connected to said equipment. Furthermore, such a layout requires management of the slack on the cables, pipes and/or elements.

Furthermore, with such a portion of aircraft, it is necessary to provide a wedge in order to hold the trim panel in position in the maintenance position so that the operator can properly carry out the maintenance operation on the equipment concerned, without the trim panel swinging around the axis of rotation. Thereof then complicates the trim panel.

### SUMMARY

One of the goals of the present disclosure is then to provide a portion of an aircraft leading to a simplified layout of the technical equipment items and while allowing easy maintenance operations on said equipment.

To this end, the subject matter of the present disclosure is a portion of an aircraft comprising:
a fuselage comprising a ceiling and a lateral portion of fuselage delimiting a cabin;
at least one technical equipment item mounted on the lateral portion of fuselage;
at least one trim panel intended for at least partially concealing from the cabin, the at least one technical equipment item;
the at least one trim panel being mounted rotatable about a horizontal axis of rotation on the ceiling between:
a trimming position wherein the trim panel at least partially conceals the at least one technical equipment item from the cabin by being held on the lateral portion of fuselage;
a maintenance position wherein the trim panel is arranged at a distance from the lateral portion of fuselage in a substantially vertical plane so as to free access to the at least one technical equipment item.

By means of the present disclosure, the equipment items are mounted on the lateral portion of the fuselage which both reduces the bulk and does not require a specific device to prevent the panel from swinging, in order to allow maintenance to be carried out. Thereof also prevents the need to provide significant lengths of electrical cables, pipes and/or mechanical elements for connection to technical equipment.

Furthermore, by means of the present disclosure, the maintenance operation is simplified since, in order to carry same out, the operator only has to move the trim panel in rotation about the horizontal axis of rotation away from the lateral potion of fuselage and to leave the panel suspended from the ceiling. Thereof gives the operator direct access to the equipment which is fastened in position relative to the side wall.

According to other advantageous aspects of the present disclosure, the portion of an aircraft comprises one or a plurality of the following features, taken individually or according to all technically possible combinations:
the fuselage extends along an axis-of-the-fuselage and has a median sagittal plane comprising the axis-of-the-fuselage, the axis of rotation being substantially parallel to the axis-of-the-fuselage, the axis of rotation being offset towards the median sagittal plane with respect to the lateral portion of fuselage;
the trim panel comprises at least one hinge mounted rotatable about the axis of rotation on the ceiling between the trimming position and the maintenance position;
the ceiling comprises a suspension bar extending substantially parallel to the axis of rotation, the trim panel comprising at least one force take-up member including a hook, the hook cooperating with the suspension bar so that the force take-up member is suspended from the suspension bar;
the trim panel comprises a main wall, the at least one hinge articulating the main wall relative to the at least one force take-up member such that:
   the main wall at least partially conceals from the cabin the at least one technical equipment item, in the trimming position; and
   the main wall is arranged away from the lateral portion of fuselage in a substantially vertical plane so as to free access to the at least one technical equipment item in the maintenance position;
the lateral portion of fuselage comprises a main wall and at least one shelf extending substantially in a horizontal plane from the main wall of the lateral portion of fuselage, the at least one technical equipment item being mounted on the at least one shelf;
the trim panel is devoid of technical equipment item;
the at least one technical equipment item comprises at least one of the following: a lighting device, a sound device, an air conditioning device, a display device, a control device for controlling another technical equipment item, an oxygen therapy device;
the portion of aircraft further comprises a locking system which can be configured between a locked configuration wherein the locking system is apt to maintain the at least one trim panel in the trimming position and an unlocked configuration wherein the locking system is apt to permit the movement of the at least one trim panel from the trimming position to the maintenance position;
the portion of aircraft further comprises a control device having a control member apt to be actuated by an operator to change the configuration of the locking system from the locked configuration to the unlocked configuration, the control member being arranged on at least one trim panel.

The present disclosure further provides a portion of an aircraft comprising:
a fuselage comprising a ceiling and a lateral portion of fuselage delimiting a cabin;
at least one technical equipment item mounted on the lateral portion of fuselage;
at least one trim panel designed to at least partially conceal the at least one technical equipment item from the cabin, comprising a main wall having an inner surface facing the ceiling and/or the lateral portion of fuselage, the main wall of the at least one trim panel being spaced from the ceiling and/or the lateral portion of fuselage by at least one gap;
the at least one trim panel being mounted rotatable about a horizontal axis of rotation between:
   a trimming position wherein the trim panel at least partially conceals from the cabin the at least one technical equipment item;
   a maintenance position wherein the trim panel is arranged so as to free the access to the at least one technical equipment item;
the portion of aircraft further comprising a locking system which can be configured between a locked configuration wherein the locking system is apt to maintain the at least one trim panel in the trimming position and an unlocked configuration wherein the locking system is apt to permit the movement of at least one trim panel from the trimming position to the maintenance position,
the portion of the aircraft further comprises a control device for controlling the locking system, including a control member apt to be actuated by an operator to change the configuration of the locking system from the locked configuration to the unlocked configuration and arranged on the inner surface of the main wall of the at least one trim panel so as to be accessible by the operator via the at least one gap when the at least one trim panel is in the trimming position;
   the locking system comprises at least one locking mechanism including a locking element mounted on the trim panel and a complementary locking element mounted on the lateral portion of the fuselage,
the locking element being movable between:
   a locking position wherein the locking element is apt to cooperate with the complementary locking element so that the locking element and the complementary locking element are rigidly attached to each other; and
   an unlocking position wherein the locking element is detached from the complementary locking element;
the control device being configured to control the at least one locking mechanism so that:
   in the locked configuration, the locking element is in the locked position; and
   in the unlocked configuration, the locking element is in the unlocked position;
   the at least one locking mechanism comprises a return element configured to constrain the locking element towards the locking position;
   the locking system comprises a plurality of locking mechanisms and a centralizing device for centralizing the control of the locking mechanisms configured so that the control device controls all the locking mechanisms so that:
   in the locked configuration, all locking elements are in the locked position; and
   in the unlocked configuration, all locking elements are in the unlocked position;
   the locking mechanisms are arranged so that the locking elements are aligned along a first line substantially parallel to the axis of rotation and the complementary locking elements are aligned along a second line substantially parallel to the first line,
the locking elements comprising a proximal locking element arranged at a proximal end of the trim panel, a distal locking element arranged at a distal end of the trim panel opposite the proximal end of the trim panel and at least one intermediate locking element located between the proximal and distal locking elements,
the centralizing device for centralizing the control of the locking mechanisms comprising:
   a central rod extending substantially along the first line through the locking elements; and
   for each locking mechanism, a tube extending around the central rod;
each tube being rigidly attached to the locking element of the corresponding locking mechanism,
each tube being movable in translation along the first line in an direction of unlocking to drive the locking element of the corresponding locking mechanism into the unlocking position and in a direction of locking opposite to the direction of locking to drive the locking element of the mechanism locking position into the locking position.
   the return element of each locking mechanism secures the corresponding locking element and the corresponding tube to the adjacent tube so that the displacement of the corresponding tube entails the displacement of the adjacent tube and of the adjacent locking element;
   the control device comprises a catch secured to a tube of the centralizing device for controlling the locking mechanisms, the catch being movable in the locking and unlocking directions, the actuation of the control device entailing the movement of the catch along the direction of unlocking, the movement of the catch along the direction of unlocking entailing the move of the tube along the direction of unlocking;
   the control member is offset from the first line along a direction of control substantially perpendicular to the first line, the control device further comprising a cable connecting the control member and the locking system;
   the control member comprises a lever movable along the direction of control, the control device further comprising a pulley cooperating with the cable so that the movement of the lever along the direction of control causes the movement of the catch along the direction of unlocking;
   the locking system comprises a rearming device configured to constrain the tubes in the direction of locking, the rearming device comprising both a stop element secured to the trim panel and a return element secured to the stop element and to at least one tube;
   the stop element is arranged between the distal locking element and the locking element neighboring the distal locking element,
the stop element comprising a body defining a cylindrical cavity through which the central rod of the locking mechanism extends, the return element of the rearming device being arranged around the central rod between the body of the stop element and the distal locking element,
the return element of the rearming device constraining all the tubes in the direction of locking;
   the locking element comprises a latch movable in rotation about an axis of rotation between a latching position wherein said latch is apt to latch a pin of the corresponding complementary locking element and a release position wherein said latch is apt to disengage from said pin,
the latch being in the latching position when the locking element is in the locking position and in the release position when the locking element is in the unlocking position,
the locking element further comprising a lever which can be actuated by the control device to drive the corresponding latch from the latching position to the release position or vice versa,
the locking element further comprising a cam secured to the lever of the locking element and a cam follower secured to the latch of the locking element, the cam and the cam follower being movable in rotation about an axis of rotation substantially parallel to the axis of rotation of the latch of the locking element,
the actuation of the locking element lever entailing a rotation of the cam about the axis of rotation thereof, the rotation of the cam about the axis of rotation thereof entailing the rotation of the cam follower to rotate about the axis of rotation thereof, the rotation of the cam follower about the axis of rotation thereof entailing the displacement of the latch of the locking element to the release position thereof;
   the at least one trim panel is mounted on the ceiling so as to be apt to rotate about the horizontal axis of rotation, the main wall of the at least one trim panel extending between an upper edge facing the ceiling and a lower edge opposite the upper edge, the upper edge being spaced from the ceiling by at least one gap;
   the gap has a width comprised between 1 cm and 5 cm.

### BRIEF SUMMARY OF THE DRAWINGS

The present disclosure will be clearer upon reading the following description, given only as an example, but not limited to, and making reference to the drawings wherein:

FIG. 1 is a simplified schematic representation of an aircraft comprising a portion of aircraft according to the present disclosure;

FIG. 2 is a simplified schematic perspective representation of a portion of the aircraft shown in FIG. 1, according to the present disclosure, wherein the trim panel is in the trimming position;

FIG. 3 is a simplified schematic perspective representation of the portion of aircraft shown in FIG. 2, wherein the trim panel is in the maintenance position;

FIG. 4 is a perspective schematic representation of the portion of aircraft shown in FIG. 2, wherein the ceiling, the lateral portion of fuselage and the technical equipment have been omitted, the locking system being in the locked configuration;

FIG. 5 is a perspective schematic representation of the portion of aircraft shown in FIG. 3, wherein the ceiling, the lateral portion of fuselage and the technical equipment have been omitted, the locking system being in the unlocked configuration;

FIG. 6 is a schematic top view representation of the portion of aircraft shown in FIG. 2, wherein the ceiling, the lateral portion of fuselage and the technical equipment have been omitted, with the locking system being in the locked configuration;

FIG. 7 is an enlarged schematic representation of a portion VII of FIG. 6; and

FIG. 8 is an enlarged schematic representation of a portion VIII of FIG. 6;

FIG. 9 is a schematic representation of an enlarged perspective view of a locking mechanism of the locking system of the portion of aircraft of FIG. 6 (more particularly the right-hand locking mechanism in FIG. 8).

### DETAILED DESCRIPTION

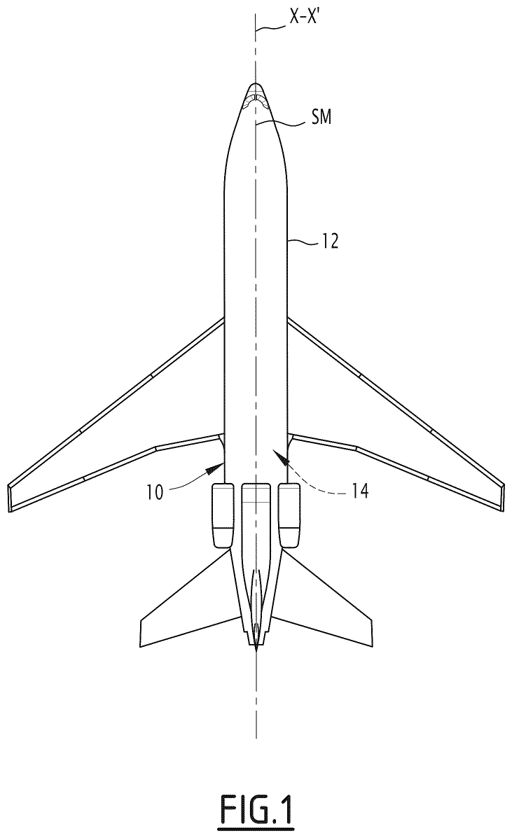

A portion of aircraft 10 according to the present disclosure is disclosed, with reference to FIGS. 1 to 9.

The portion of aircraft 10 comprises a fuselage 12, at least one technical equipment item 30 and at least one trim panel 40 intended to at least partially conceal from a cabin 14 of the aircraft, the at least one technical equipment item 30.

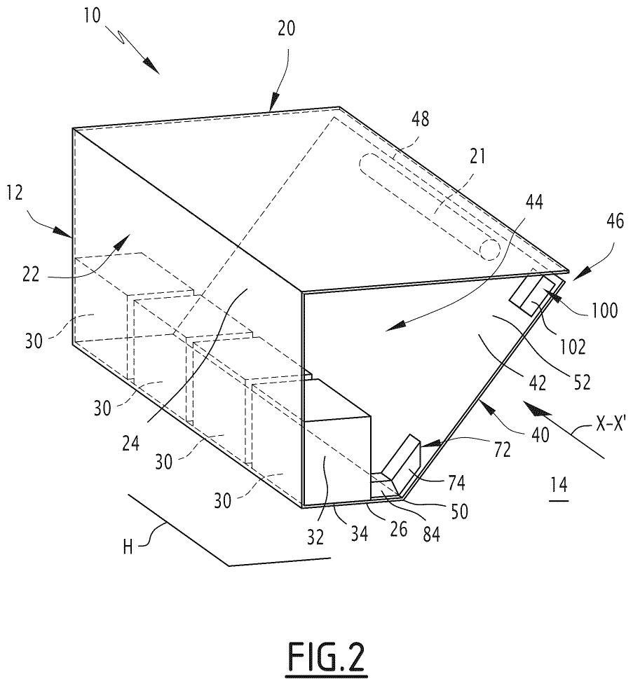

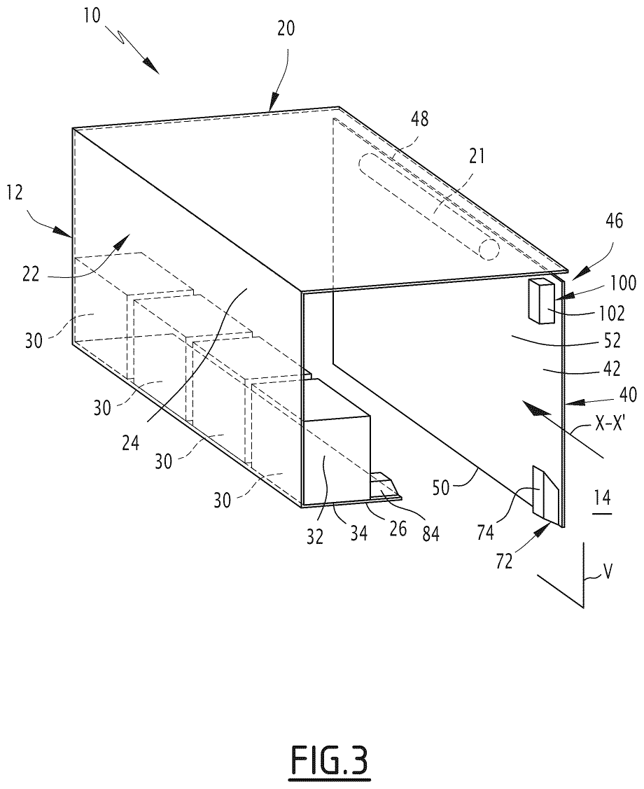

Hereinafter, a portion of an aircraft 10 is described comprising a plurality of technical equipment items 30 (in particular four technical equipment items 30 as illustrated in the examples shown in FIGS. 2 and 3) and a single trim panel 40. Of course, the skilled person would understand that the present disclosure also applies in cases where the portion of aircraft 10 comprises only one technical equipment item 30 and/or a plurality of trim panels 40.

The portion of aircraft 10 further comprises a floor (not shown) delimiting along with the fuselage 12, the cabin 14.

Advantageously, the portion of aircraft 10 further comprises a locking system 70 and a control device 100 for controlling the locking system 70.

With reference to FIG. 1, the fuselage 12 extends along an axis-of-the-fuselage X-X′ and has a median sagittal plane SM comprising the axis-of-the-fuselage X-X′.

The fuselage 12 comprises a ceiling 20 and a lateral portion of fuselage 22 delimiting the cabin 14.

In the example shown in FIGS. 2 and 3, the ceiling 20 extends substantially parallel to the floor and substantially perpendicular to the median sagittal plane SM of the aircraft. However, the present disclosure is not limited to such a ceiling 20 and a person skilled in the art would understand that the ceiling 20 may have a different shape, such as, e.g., a vaulted shape.

For example, the ceiling 20 comprises a suspension bar 21 extending substantially parallel to an axis of rotation R1 of the trim panel 40.

In the example of FIGS. 2 and 3, the lateral portion of fuselage 22 extends substantially perpendicularly to the floor and substantially parallel to the median sagittal plane SM of the aircraft. However, the present disclosure is not limited to such a lateral portion of fuselage 22 and the skilled person would understand that the lateral portion of fuselage 22 may have a different shape, such as e.g., a curved shape.

Advantageously, the lateral portion of fuselage 22 comprises a main wall 24 and at least one shelf 26 extending substantially in a horizontal plane H from the main wall 24. “Horizontal” means a plane extending substantially parallel to the floor of the portion of aircraft 10.

More particularly, the main wall 24 of the lateral portion of the fuselage 22 delimits along with the floor and the ceiling 20, the cabin 14.

In particular, the shelf 26 is intended to be arranged above a passenger zone of the aircraft e.g. above aircraft seats, an aircraft bed, or other.

The technical equipment items 30 are mounted on the lateral portion of fuselage 22.

More particularly, as illustrated in the example of FIGS. 2 and 3, the technical equipment items 30 are mounted on the shelf 26.

The technical equipment items 30 comprise at least one of the following: a lighting device, a sound device, an air conditioning device, a display device, a control device for controlling other technical equipment items, an oxygen therapy device.

For example:
the lighting device comprises a reading light, a night light or other;
the air conditioning system includes an air vent, an adjustable-flow blower or other;
the display device comprises electronic signage, a screen or other;
the control device comprises a button or other; and/or
the oxygen therapy device comprises an oxygen container, an oxygen mask, suitable piping or other.

In particular, the technical equipment items 30 each comprises a main part 32 intended not to be accessible from the cabin 14 under normal conditions of use of the aircraft (excluding e.g. maintenance) in order e.g. to protect the main part 32 and/or to improve the aesthetics of the cabin 14. More particularly, the main parts 32 of the technical equipment 30 comprise electronic, hydraulic and/or mechanical components ensuring the operation of lighting, sound, air conditioning, display, control and/or oxygen therapy devices but not requiring access by anyone under normal conditions of use of the aircraft.

For example, each item of technical equipment 30 comprises an auxiliary part 34 intended to be permanently accessible from the cabin 34 under normal conditions of use of the aircraft, e.g. to enable passengers of the aircraft to control the main part 32. In particular, the auxiliary parts 34 of the technical equipment 30 comprise buttons, screens, lights, ventilation openings, illuminated pictograms, etc.

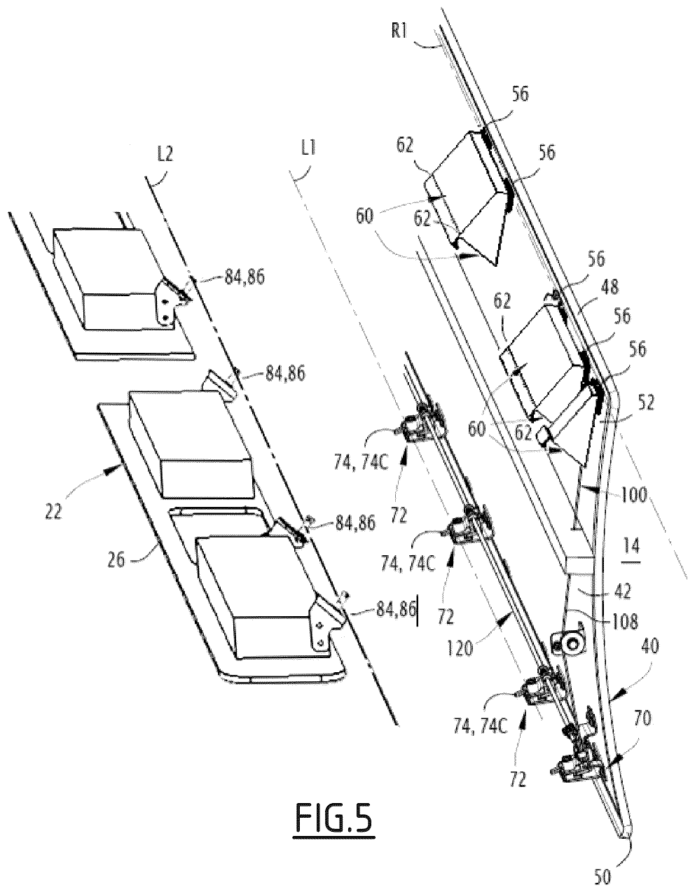

The trim panel 40 is mounted apt to rotate about the axis of rotation R1 which is horizontal, in particular on the ceiling 20 between a trimming position (visible in FIGS. 2, 4 and 6 to 9) and a maintenance position (visible in FIGS. 3 and 5).

In the trimming position, the trim panel 40 conceals at least partially the technical equipment items 30 from the cabin 14, in particular the main parts 32 of the technical equipment items 30, by being retained on the lateral portion of the fuselage 22.

In the maintenance position, the trim panel 40 is arranged at a distance from the lateral portion of fuselage 22 in a substantially vertical plane V (see FIG. 3) so as to free access to the technical equipment items 30, in particular to the main parts 32 of the technical equipment 30.

For example, the trim panel 40 does not have any technical equipment 30. In other words, none of the technical equipment 30 of the portion of aircraft 10 is comprised in and/or mounted on the trim panel 40.

For example, the axis of rotation R1 is substantially parallel to the axis-of-the-fuselage X-X′ and is offset towards the median sagittal plane SM with respect to the lateral portion of fuselage 22.

Advantageously, the trim panel 40 comprises a main wall 42, at least one hinge 56 and at least one force take-up member 60.

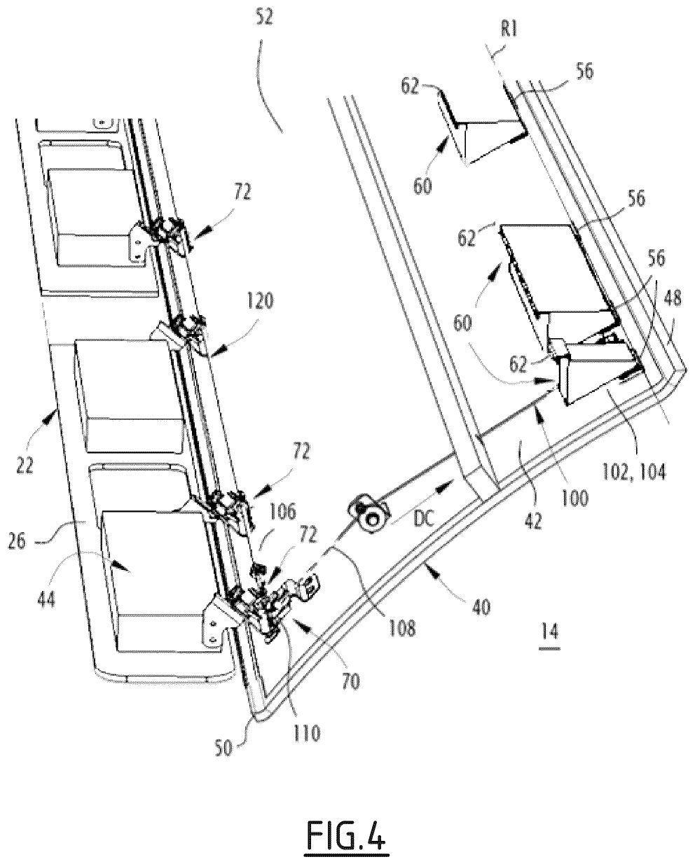

In the example shown in FIGS. 4 to 9, the trim panel 40 comprises a main wall 42, a plurality of hinges 56 and a plurality of force take-up members 60. The example shown in FIGS. 4 to 9 is described hereinafter in more detail. Of course, the present disclosure also applies in the case where the trim panel 40 comprises only one hinge 56 and/or only one force take-up member 60.

In the trimming position, the main wall 42 of the trim panel 40 delimits along with the ceiling 20 and the lateral portion of fuselage 22, in particular the main wall 24 of the lateral portion of fuselage 22 and the shelf 26, a space 44 for receiving the technical equipment 30.

In the trimming position, the main wall 42 of the trim panel 40 at least partially conceals the technical equipment items 30 from the cabin 14 by being held on the lateral portion of fuselage 22, in particular on the shelf 26. More particularly, in the trimming position, the main wall 42 completely conceals from the cabin 14, the main parts 32 of the technical equipment 30.

In the maintenance position, the main wall 42 of the trim panel 40 is arranged at a distance from the lateral portion of fuselage 22 in the substantially vertical plane V so as to free access to the technical equipment items 30.

Advantageously, the main wall 42 of the trim panel 40 is spaced from the ceiling 20 and/or from the lateral portion of fuselage 22 by at least one gap 46.

According to the example illustrated in FIGS. 2 and 3, the main wall 42 of the trim panel 40 is spaced from the ceiling 20 by at least one gap 46, in particular a gap 46 extending substantially parallel to the axis of rotation R1.

In particular, the main wall 42 of the trim panel 40 has an upper edge 48 intended to extend facing the ceiling 20 and a lower edge 50 opposite the upper edge 48 intended to extend facing the lateral portion of fuselage 22.

According to the example illustrated in FIGS. 2 and 3, the upper edge 48 of the main wall 42 of the trim panel 40 is spaced from the ceiling 20 by the gap 46.

For example, the 46 has a width comprised between 1 cm and 5 cm.

The main wall 42 of the trim panel 40 has an inner surface 52 oriented towards the ceiling 20 and/or the lateral portion of fuselage 22. In particular, the inner surface 52 is oriented towards the technical equipment items 30 in the trimming position and in the maintenance position.

The hinges 56 are rotatably mounted about the axis of rotation R1 on the ceiling 20, in particular by means of the force take-up members 60, between the trimming position and the maintenance position.

In particular, the hinges 56 allow the main wall 42 of the trim panel 40 to be moved in rotation between the trimming position and the maintenance position.

More particularly, the hinges 56 articulate the main wall 42 of the trim panel 40 with respect to the force take-up members 60 so that the main wall 42 of the trim panel 40 can be moved between the trimming and the maintenance positions.

The force take-up members 60 each include a hook 62 cooperating with the suspension bar 21 so that the force take-up member 60 is suspended from the suspension bar 21.

The locking system 70 can be configured between a locked configuration wherein the locking system 70 is apt to keep the trim panel 40 in the trimming position and an unlocked configuration wherein the locking system 70 is apt to permit the displacement of the trim panel 40 from the trimming position to the maintenance position.

Advantageously, the locking system 70 comprises at least one locking mechanism 72, in particular a plurality of locking mechanisms 72, as illustrated in the example of FIGS. 4 to 9. The example shown in FIGS. 4 to 9 is described hereinafter in more detail. Of course, the present disclosure also applies in the case where the locking system 70 comprises only one locking mechanism 72.

Also advantageously, the locking system 70 comprises a centralizing device 120 for centralizing the control of the locking mechanisms 72.

Also advantageously, the control device 70 further comprises a rearming device 130.

The locking mechanisms 72 each comprise a locking element 74 and a complementary locking element 84.

Advantageously, the locking mechanisms 72 each comprise a return element 90 configured to constrain the locking element 74 towards a locking position described in greater detail hereinbelow.

The locking mechanisms 72 are arranged so that the locking elements 74 are aligned along a first line L1 substantially parallel to the axis of rotation R1 and the complementary locking elements 84 are aligned along a second line L2 substantially parallel to the first line L1.

The locking elements 74 are mounted on the trim panel 40, in particular on the inner surface 52 of the main wall 42 of the trim panel 40.

With reference to FIGS. 4 to 9, the locking elements 74 comprise a proximal locking element 74A arranged at a proximal end 76A of the trim panel 40, a distal locking element 74 B arranged at a distal end 76B of the trim panel 40 opposite the proximal end 76A of the trim panel 40 and, e.g., at least one intermediate locking element 74C located between the proximal locking element 74A and the distal locking element 74B. Herein, the proximal 76A and distal 76B ends are defined along the axis-of-the-fuselage X-X′.

Each locking element 74 can be moved between:
a locking position wherein said locking element 74 is apt to cooperate with the corresponding complementeray locking element 84, so that said locking element 74 and said complementary locking element 84 are rigidly attached to each other; and
an unlocking position wherein said locking element 74 is detached from said complementary locking element 84.

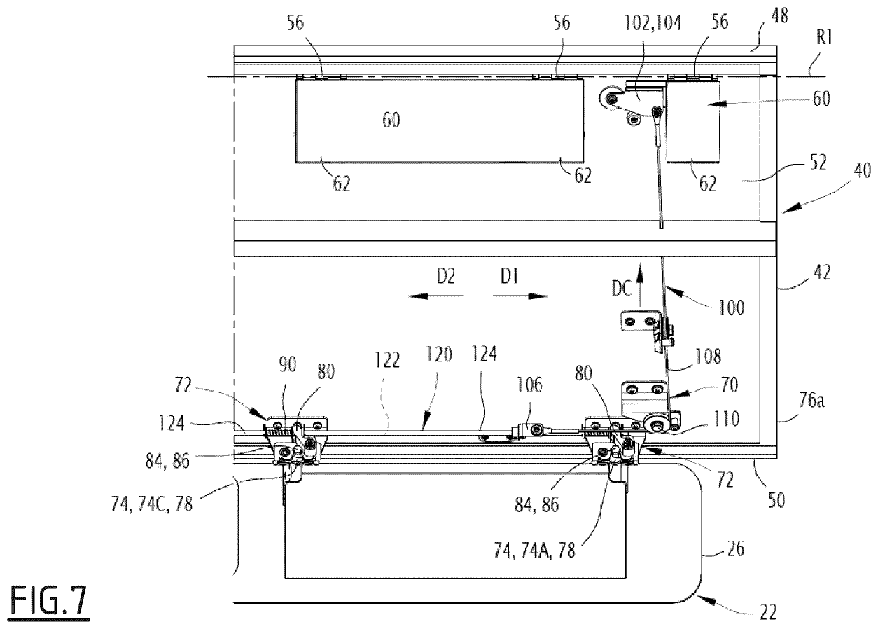

For example, as can be seen in FIGS. 5 and 7 to 9, each locking element 74 comprises a latch 78 that is movable in rotation about an axis of rotation R2 between a latching position (visible in FIGS. 7 to 9) wherein said latch 78 is apt to latch a pin 86 of the corresponding complementary locking element 84 and a release position (visible in FIG. 5) wherein said latch 78 is apt to disengage from said pin 86.

For each locking element 74, in the locking position, the corresponding latch 78 is in the latching position, and in the unlatching position, the corresponding latch 78 is in the release position.

Advantageously, as can be seen in FIGS. 7 to 9, each locking element 74 further comprises a lever 80 apt to be actuated by the control device 100 to move the corresponding latch 78 from the latching position to the release position or vice versa.

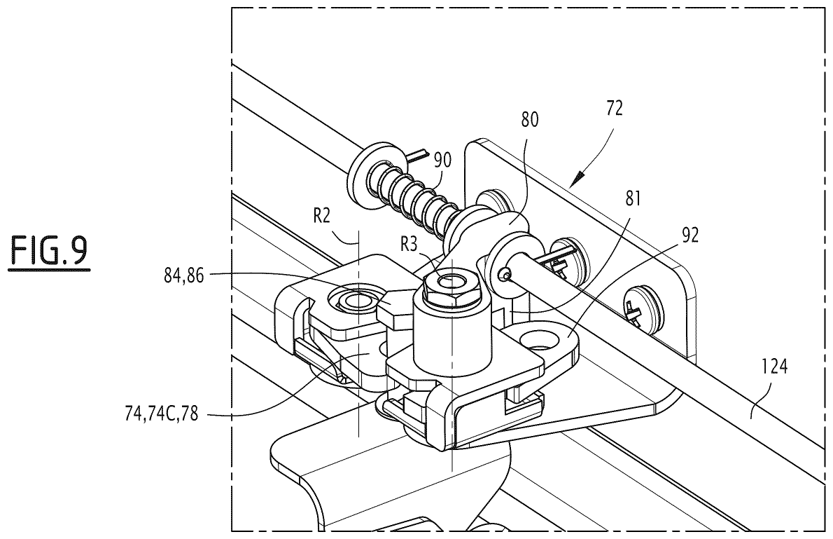

With reference to FIG. 9, each locking element 74 advantageously further comprises a cam 81 secured to the lever 80 of the corresponding locking element 74 and a cam follower 92 secured to the latch 78 of the corresponding locking element 74.

The cam 81 and the cam follower 92 are in particular movable in rotation about an axis of rotation R3 substantially parallel to the axis of rotation R2 of the latch 78 of the corresponding locking element 74.

For each locking element 74, the actuation of the lever 80, more particularly by the control device 100, entails a rotation of the cam 81 about the axis of rotation R3 thereof, in particular in a first direction, which entails the rotation of the cam follower 92 about the axis of rotation R3 thereof, in particular in said first direction, which entails the displacement of the latch 78 of the corresponding locking element 74 towards the release position thereof.

Advantageously, the locking element 74 further comprises a return member (not visible in the Figures) which, in the absence of actuation of the lever 80, is configured to constrain the cam follower 92 in rotation about the axis of rotation R3 thereof, in particular in a second direction opposite to the first direction, which constrains the movement of the latch 78 of the corresponding locking element 74 towards the latching position thereof.

The use of the cam 81, the cam follower 92 and advantageously the return member configured to constrain the cam follower 92, makes it possible to compensate for plays in the locking system 70, which could otherwise adversely affect the simultaneous locking or unlocking of all the locking mechanisms 72.

The complementary locking elements 84 are mounted on the lateral portion of the fuselage 22, more particularly on the shelf 26.

For example, each complementary locking element 84 comprises a pin 86.

More particularly, the pins 86 are fastened on the lateral portion of fuselage 22, in particular on the shelf 26. Advantageously, the pins 86 extend towards the trim panel 40.

Advantageously, the return element 90 of each locking mechanism 72 rigidly attaches:
the corresponding locking element 74 and a corresponding tube 124 (described in more detail hereinbelow); to
an adjacent tube 124;
in such a way that the displacement of the corresponding tube 124 entails the displacement of the adjacent tube 124 and of the neighbor locking element 74.

The control device 100 includes a control member 102 apt to be actuated by an operator to change the configuration of the locking system 70 from the locked configuration to the unlocked configuration.

Advantageously, the control device 100 further comprises a catch 106.

Again advantageously, the control device 100 further comprises a cable 108 linking the control member 102 and the locking system 70.

Again advantageously, the control device 100 further comprises a pulley 110 cooperating with the cable 108.

More particularly, the control device 100 is configured to control the locking mechanisms 72 so that:
in the locked configuration, the locking elements 74 are in the locked position; and
in the unlocked configuration, the locking elements 74 are in the unlocked position.

With reference to FIG. 7, the control member 102 is arranged on the trim panel 40, more particularly on the inner surface 52 of the main wall 42 of the trim panel 40 so as to be accessible by the operator via the gap 46 when the trim panel 40 is in the trimming position. According to the example illustrated in FIGS. 2 to 8, the control member 102 is arranged close to the upper edge 48 of the main wall 42 of the trim panel 40.

Advantageously, the control member 102 is offset from the first line L1 along a control direction DC substantially perpendicular to the first line L1.

Again advantageously, the control member 102 comprises a lever 104 which can be moved along the control direction DC.

More particularly, the actuation of the control member 102 entails the displacement of the catch 106 in a direction of unlocking D1.

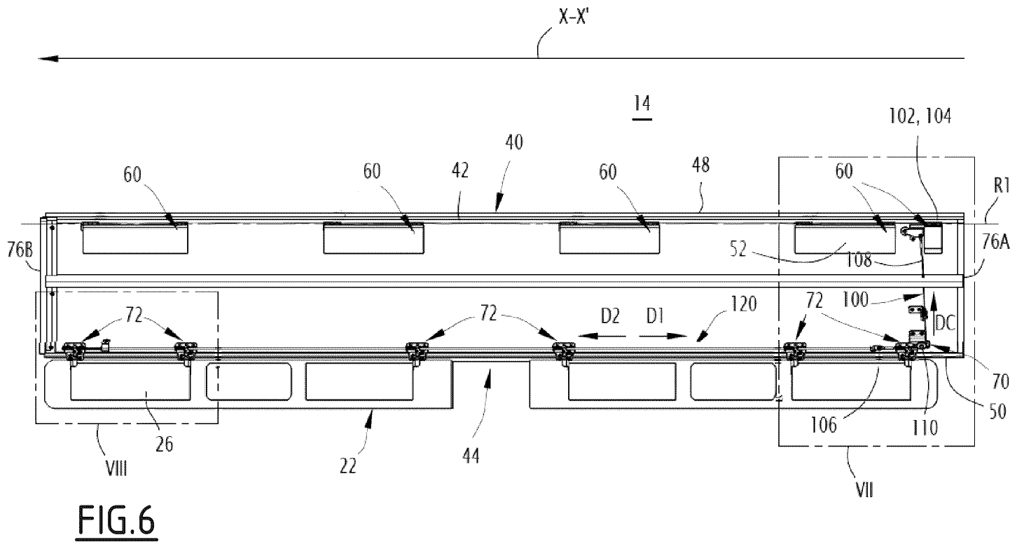

With reference to FIG. 7, the catch 106 is secured to a tube 124 of the centralizing device 120 for centralizing the control of the locking mechanisms 72. For example, as illustrated in FIGS. 6 and 7, the catch 106 is secured to the tube 124 extending between the proximal locking element 74A and the locking element 74 adjacent to the proximal locking element 74A.

The catch 106 can move in a direction of locking D2 and in the direction of unlocking D1.

The displacement of the catch 106 in the direction of unlocking D1 entails the displacement of the tube 124 to which the catch 106 is rigidly attached in the direction of unlocking D1. Advantageously, the displacement of the tube 124 to which the catch 106 is secured in the direction of unlocking D1 entails the gradual displacement of the other tubes 124 in the direction of unlocking D1.

With reference to FIGS. 4 to 7, for example, the cable 108 mechanically connects the lever 104 of the control member 102 and the locking system 70, in particular by mechanically linking the lever 104 of the control member 102 and the catch 106 of the control device 100.

With reference to FIG. 7, the pulley 110 cooperates with the cable so that the displacement of the lever 104 of the control member 102 in the control direction DC entails the displacement of the catch 106 in the direction of unlocking D1.

With reference to FIGS. 4 to 8, the centralizing device 120 for centralizing the control of the locking mechanisms 72 is configured so that the control device 100 controls all of the locking mechanisms 72 so that:
in the locked configuration, all locking elements 74 are in the locking position; and
in the unlocked configuration, all locking elements 74 are in the unlocking position.

In particular, the device 120 for centralizing the control of the locking mechanisms 72 comprises:
a central rod 122 extending substantially along the first line L1 through the locking elements 74, in particular through the levers 80 of the locking elements 74; and
for each locking mechanism 72, a tube 124 extending around the central rod 122.

With reference to FIG. 6, each tube 124 is secured to the locking element 74 of the corresponding locking mechanism 72, in particular to the corresponding lever 80.

Each tube 124 is movable in translation along the first line L1:
in the direction of unlocking D1 to move the locking element 74 of the corresponding locking mechanism 72 into the unlocking position, in particular by actuating the corresponding lever 80; and
in the direction of locking D2 opposite to the direction of locking D1 to move the locking element 74 of the corresponding locking mechanism 72 into the locking position, in particular by actuating the corresponding lever 80.

The rearming device 130 is configured to constrain the tubes 124 along the direction of locking D2.

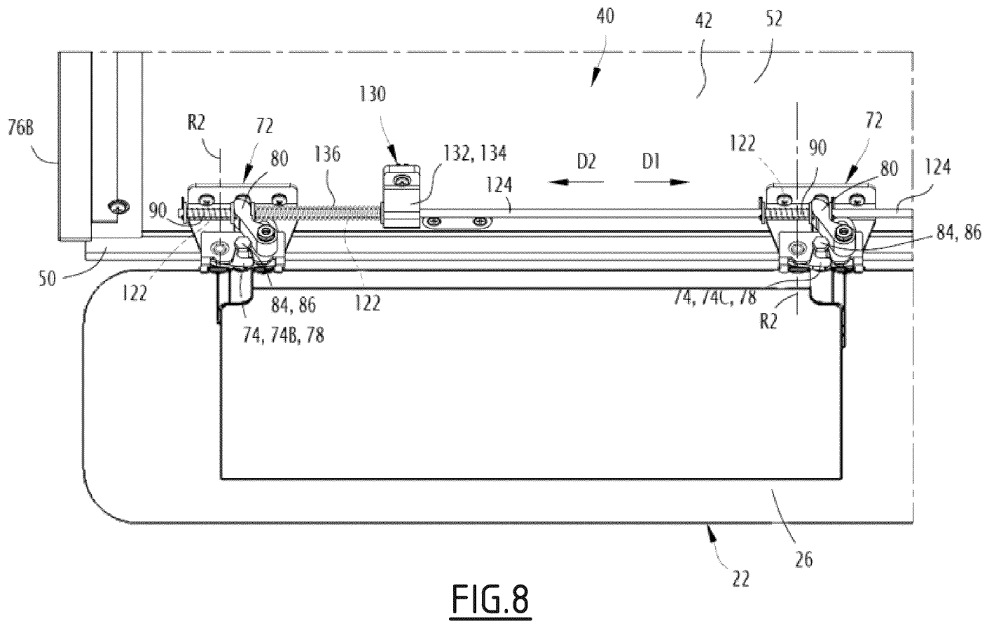

With reference to FIG. 8, the rearming device 130 comprises a stop element 132 rigidly attached to the trim panel 40, in particular mounted on the inner surface 52 of the main wall 42 of the trim panel 40, and a return element 136 secured both to the stop element 132 and to at least one tube 124.

The stop element 132 is more particularly arranged between the distal locking element 74B and the locking element 74 neighboring the distal locking element 74B.

The stop element 132 comprises a body 134 delimiting a cylindrical cavity through which the central rod 122 of the centralization device 120 extends.

The return element 136 of the rearming device 130 is arranged around the central rod 122 between the body 134 of the stop element 132 and the distal locking element 74B, in particular the lever 80 of the distal locking element 74B.

The return element 136 of the rearming device 130 constrains the set of tubes 124 in the direction of locking D2, in particular by constraining the lever 80 of the distal locking element 74B so that same is actuated so that the distal locking element 74B is in the locking position. Consequently, through the action of the return elements 90, each locking element 74 is moved to the locking position.

The use of the portion of aircraft 10 is described hereinafter.

It is considered that initially, the trim panel 40 is in the trimming position.

When an operator wishes to have access to the technical equipment 30, in particular to the main parts 32 of the technical equipment items 30, e.g. to perform maintenance on the technical equipment items 30, the operator moves the trim panel 40 from the trimming position to the maintenance position.

To this end, e.g. before moving the trim panel 40, the operator actuates the control member 102 to change the configuration of the locking system 70 from the locked configuration to the unlocked configuration.

In particular, the operator has access to the control member 102 via the gap between, on the one hand, the main wall 42 of the trim panel 40 and, on the other hand, the ceiling 20 and/or the lateral portion of fuselage 22.

Once the locking system 70 is in the unlocked configuration, the trim panel 40 is moved by the operator and/or by the effect of gravity to the maintenance position.

Once the maintenance has been carried out, the operator moves the trim panel 40 to the trimming position. Once in the trimming position, the trim panel 40 is kept in the trimming position since the locking system 70 has switched backed to the locked configuration.

By means of the present disclosure, the overall volume taken up by the technical equipment items 30 is reduced since the equipment items are no longer mounted on the panel 40. Furthermore, there is no need to resort to a specific device to prevent the panel from swinging in order to stabilize the panel when maintenance is performed on equipment attached to the panel. Furthermore, there is no need to resort to significant lengths of electrical cables, pipes and/or mechanical elements since it is no longer necessary to provide lengths at least sufficient to allow the panel fitted with equipment to move.

Furthermore, by means of the present disclosure, the maintenance operation is simplified since the operator only has to move the panel in rotation about the horizontal axis of rotation away from the lateral potion of fuselage and to leave the panel suspended from the ceiling. The equipment is attached in position relative to the side wall and the operator can directly perform maintenance operations on the equipment that is stable in position.

Also, by means of the present disclosure, very simple locking and unlocking in position are provided. The locking system is space-saving and can be easily actuated via the control member. The control member is concealed to the passengers of the aircraft who are in the cabin, but remains easily accessible by the operator when maintenance is required.

The centralizing device for the control of the locking mechanisms makes it easy to control all the locking mechanisms by means e.g. of only one control device.

What is claimed is:

1. A portion of aircraft comprising:
a fuselage comprising a ceiling and a lateral portion of fuselage delimiting a cabin;
at least one technical equipment item mounted on the lateral portion of fuselage; and
at least one trim panel intended for at least partially concealing from the cabin, the at least one technical equipment item;
the at least one trim panel being mounted rotatable about a horizontal axis of rotation on the ceiling between:
a trimming position wherein the trim panel at least partially conceals the at least one technical equipment item from the cabin by being held on the lateral portion of fuselage; and
a maintenance position wherein the trim panel is arranged at a distance from the lateral portion of fuselage in a substantially vertical plane so as to free access to the at least one technical equipment item.

2. The portion of aircraft according to claim 1, wherein the fuselage extends along an axis-of-the-fuselage and has a median sagittal plane comprising the axis-of-the-fuselage, the axis of rotation being substantially parallel to the axis-of-the-fuselage, the axis of rotation being offset towards the median sagittal plane with respect to the lateral portion of fuselage.

3. The portion of aircraft according to claim 1, wherein the trim panel comprises at least one hinge mounted rotatable about the axis of rotation on the ceiling between the trimming position and the maintenance position.

4. The portion of aircraft according to claim 1, wherein the ceiling comprises a suspension bar extending substantially parallel to the axis of rotation, the trim panel comprising at least one force take-up member including a hook, the hook cooperating with the suspension bar so that the force take-up member is suspended from the suspension bar.

5. The portion of aircraft according to claim 4, wherein the trim panel comprises a main wall, the at least one hinge articulating the main wall relative to the at least one force take-up member such that:
the main wall at least partially conceals from the cabin the at least one technical equipment item, in the trimming position; and
the main wall is arranged away from the lateral portion of fuselage in a substantially vertical plane so as to free access to the at least one technical equipment item in the maintenance position.

6. The portion of aircraft according to claim 1, wherein the lateral portion of fuselage comprises a main wall and at least one shelf extending substantially in a horizontal plane from the main wall of the lateral portion of fuselage, the at least one technical equipment item being mounted on the at least one shelf.

7. The portion of aircraft according to claim 1, wherein the trim panel is devoid of technical equipment item.

8. The portion of aircraft according to claim 1, wherein the at least one technical equipment item comprises at least one of the following:
a lighting device;
a sound device; an air conditioning device;
a display device;
a control device for controlling another technical equipment item; and/or an oxygen therapy device.

9. The portion of aircraft according to claim 1, wherein the portion of aircraft further comprises a locking system which can be configured between a locked configuration,
wherein the locking system is apt to maintain the at least one trim panel in the trimming position and an unlocked configuration,
wherein the locking system is apt to permit the movement of the at least one trim panel from the trimming position to the maintenance position.

10. The portion of aircraft according to claim 9, further comprising a control device having a control member apt to be actuated by an operator to change the configuration of the locking system from the locked configuration to the unlocked configuration, the control member being arranged on the at least one trim panel.
